(19) United States
(12) Patent Application Publication
(10) Pub. No.: US 2023/0382569 A1
(43) Pub. Date: Nov. 30, 2023

(54) LOW NOISE VERTICAL TAKE-OFF AND LANDING (VTOL) UNMANNED AIR VEHICLE (UAV)

(71) Applicant: Undefined Technologies Corp., Doral, FL (US)

(72) Inventor: Tomas A. Pribanic, Doral, FL (US)

(21) Appl. No.: 18/027,661

(22) PCT Filed: Sep. 23, 2021
(86) PCT No.: PCT/US21/51636

§ 371 Date: Mar. 22, 2023

Related U.S. Application Data
(60) Provisional application No. 63/083,965, filed on Sep. 27, 2020.

(51) Int. Cl. B64U 10/20; B64U 60/50; B64U 20/20; B64U 50/18; H05K 7/20; F03H 1/00

(52) U.S. Cl. CPC B64U 10/20; B64U 60/50; B64U 20/20; B64U 50/18; H05K 7/20145; F03H 1/0037; B64U 2101/30

(57) ABSTRACT

Low noise vertical take-off and landing (VTOL) unmanned air vehicle. A vertical take-off and landing unmanned vehicle which generates low levels of noise includes an ion thruster providing a thrust in a vertical direction, and a thrust vectoring system providing thrust in at least one of a forward, aft, left, and right direction, when the unmanned vehicle is in flight

### CROSS REFERENCE TO RELATED APPLICATION

This application claims the benefit of U.S. Provisional Application No. 63/083,965 filed on Sep. 27, 2020, the entire disclosure of which is hereby incorporated in its entirety.

### BACKGROUND OF THE INVENTION

The present invention relates to an unmanned aerial vehicle (“UAV”) propelled with the use of electrical sources (electric propulsion) with the use of asymmetrical electrodes subjected to a potential (voltage) differential and a vector thrusting device. The combination of these two system results in a low noise generating vertical takeoff and landing (“VTOL”) craft.

Existing rotary thrusting technology (i.e. propellers, turbines) require rotating components at high speed which generate high levels of noise. In most cases, the noise generated by the pressure wave resulting from the rotating member circulating in the surrounding fluid (i.e. air) exceeds the safe threshold of decibels (Db) of human hearing. Additionally, rotating thrust technologies generate noise at high frequency with has an adverse effect in the psychological well-being of humans.

An alternative to rotary thrust generating technologies is the use of thrust generated by electrodes subjected to a high potential (voltage) differential. This non-rotating thrusting technology has the advantage of being capable of generating very low levels of noise (70 dB and below) during operation.

Generation of thrust from electrodes subjected to a potential differential was first discovered in 1928 by T. T. Brown. Since then, numerous concepts have emerged using this principle to generate thrust to propel vehicles. Various proposed embodiments have used different electrode arrangements and configurations to increase the thrust levels. However, the basic principle used by Brown has remained unchanged in these inventions.

Thrust using electrodes at high potential difference is achieved by using electrodes of significantly different sizes relative to each other; having opposite voltage polarity. A smaller electrode (having higher current density) attracts existing opposite charged ions and/or electrons from the surrounding medium (i.e. air, nitrogen, xenon gas) at high speeds. On their path, these ions or electrons collide with neutral molecules. These collisions cause the neutral molecules to gain or lose an electron. The impacted molecules, now polarized, are attracted to the larger electrode at high speed and their acceleration generates thrust.

In atmospheric conditions, ion thrusters which can generate thrust levels that allow an aircraft with VTOL capabilities had not been previously achieved due to inefficiencies in the designs and lack of an agile response system to attain a controlled level flight.

Embodiments of the present invention herein overcome the shortcomings of the prior art by combining the use of a highly optimized ion thruster to produce lift while using an auxiliary thrust vectoring system to achieve VTOL flight with low noise levels and high flight control capabilities.

### SUMMARY OF THE INVENTION

A vertical take-off and landing (VTOL) unmanned vehicle which generates low levels of noise has an ion thruster providing a thrust in a vertical direction, and a thrust vectoring system providing thrust in at least one of a forward, aft, left, and right direction when the unmanned vehicle is in flight. The thrust vectoring device controls the roll, pitch, and yaw of the craft.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, explain the principles of the invention. The drawings are only for the purpose of illustrating one or more embodiments of the invention and are not to be construed as limiting the invention. In the drawings:

FIG. 1 is a top perspective view of an ion thrust VTOL craft constructed in accordance with a first embodiment of the invention;

FIG. 2 is a cross-sectional schematic view of the ion thruster electrodes constructed in accordance with the invention;

FIG. 3 is a bottom perspective view of an embodiment of the invention;

FIG. 4 is a sectional view taken along line 4-4 of FIG. 1;

FIG. 5 is a block diagram of the ion thrust system and thrust vectoring system;

FIG. 6 shows the experimental set up for testing an embodiment of the invention;

FIG. 7 is a plan view ion thrust VTOL craft constructed in accordance with a second embodiment of the invention fitted to deliver cargo;

FIG. 8 is a plan view ion thrust VTOL craft constructed in accordance with a third embodiment of the invention fitted for surveillance use;

FIG. 9 is a plan view ion thrust VTOL craft constructed in accordance with a fourth embodiment of the invention retrofitted a multi-copter; and

FIGS. 10A, 10B are respective bottom perspective views of the thrust vectoring system showing respective articulation modes of the thrust vectoring fins.

### DETAILED DESCRIPTION OF THE INVENTION

In the following detailed description, numerous specific details are set forth in order to provide a thorough understanding of the embodiments of the invention. However, upon reading the below description, it will be understood by one of ordinary skill in the art that the embodiments may be practiced without these specific details. For instance, well known operation or techniques may not be shown in detail. Technical and scientific terms used in this description have the same meaning as commonly understood to one or ordinary skill in the art to which this subject matter belongs.

As used throughout this application, the term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (i.e. “top,” “bottom,” “FWD,” “AFT, “above,” “below”) are merely used to describe the orientation of various elements in the figures. It should be noted that the orientation of various elements may differ according to other exemplary embodiments, and that such variations are intended to be encompassed by the present disclosure.

Embodiments of the present invention provide a technology-based solution that overcomes existing problems with the current state of the art in a technical way to satisfy lowering Drone Noise for Private, Commercial, and Military applications.

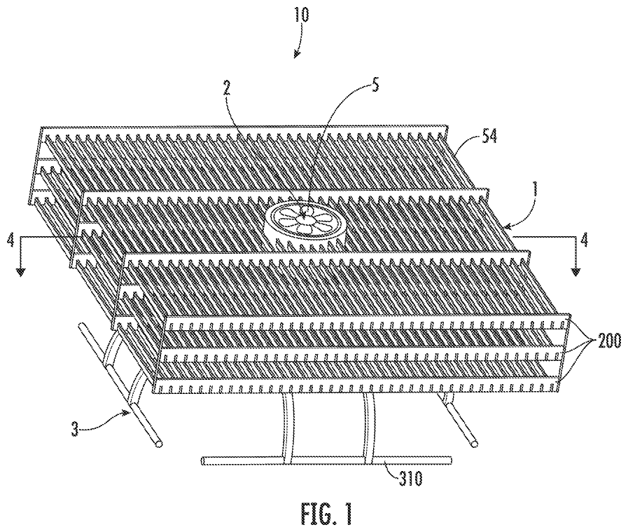

Referring in more detail to FIG. 1, according to an embodiment of the invention, the UAV or craft 10 consists of an ion thruster 1, in one preferred non limiting embodiment, consisting of three geometrically identical levels (stages) of electrode pairs 50, a thrust vectoring system 2, and a landing gear 3 including a plurality landing skids 310 to provide support when the craft 10 is in contact with the ground.

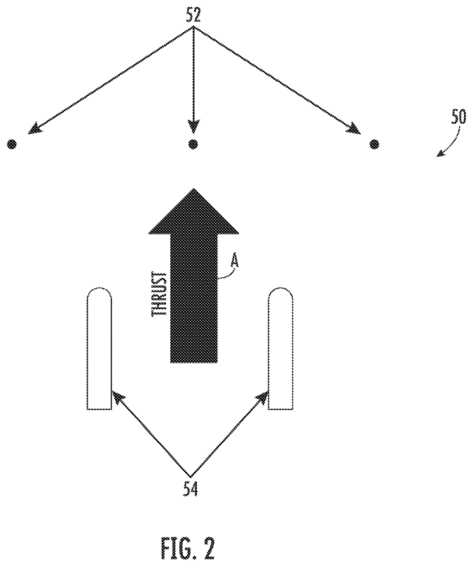

Each level or stage of the ion thruster 1, consists of a series of electrode pairs 50 (top electrode 52 and bottom electrode 54; collectively or singularly sometimes referred to as electrode(s)) fixed parallel to each other. FIG. 2 shows the cross-sectional view of an electrode pair 50 of one of the levels, of the series of paired electrodes 50 of the ion thruster 1. One or more bottom electrodes 54 serve as members to carry the opposite voltage potential to their corresponding one or more top electrodes 52.

Additionally, as seen in FIG. 1 by way of nonlimiting example, a plurality of the bottom electrodes 54 extend across a frame 200 of craft 10, and as a result are also part of the primary structure of the craft 10 acting in part, as part of frame 200 for a portion of the structure. The thrust generated by the ion thruster 1 is directed in the direction of arrow A; in the direction of top electrodes 52. It is possible to control thrust by controlling the thrust of each stage/level of electrodes 50. When thrust is generated in the same direction amongst the various levels, the force is cumulative, so that thrust, and resulting speed, in a vertical direction may be controlled by the number of electrodes 50 which are energized at any given time.

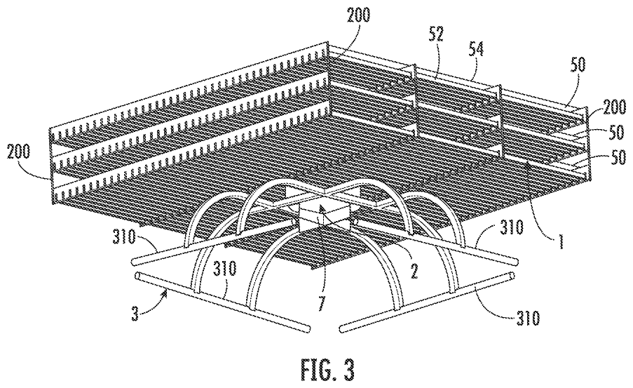

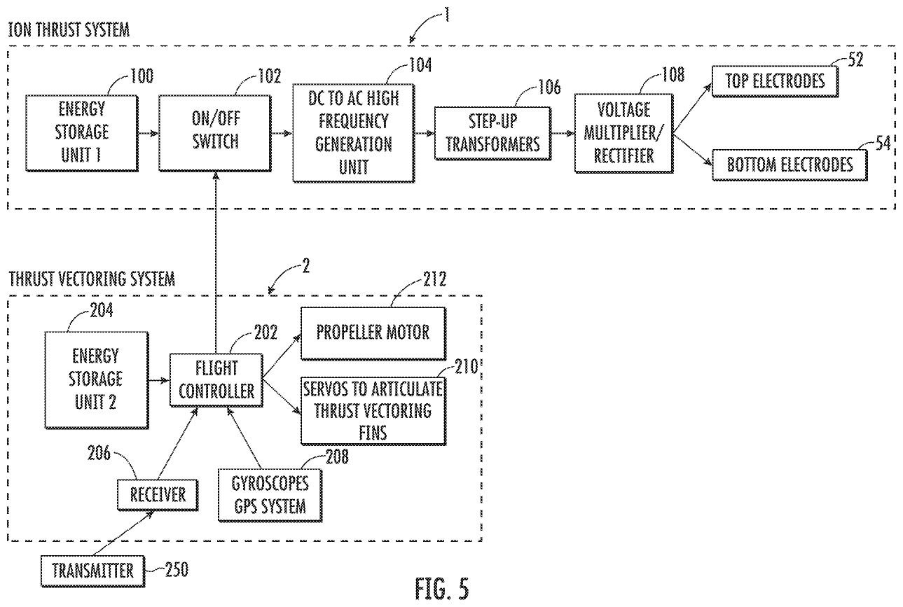

FIG. 3 shows a bottom isometric view of the invention. The thrust vectoring system 2, is, in a preferred non limiting embodiment, a small rotating thrust generation system (secondary thrust system) having impellers 5 coupled to a rotating motor (FIG. 5) and spindle coupled to pivoting fins 7; each connected to a servo 210. A variety of rotary thrust generating systems can be used in the invention, including, but not limited to, rotary propellers, counter-rotating propellers, duct fans, electric or gas jet engines, or the like. As a result in addition to providing additional thrust, a flow of air generated by the small rotating system 7, disposed within a housing 9 of thrust vectoring system 2, is used to cool down the electronics of the craft 10.

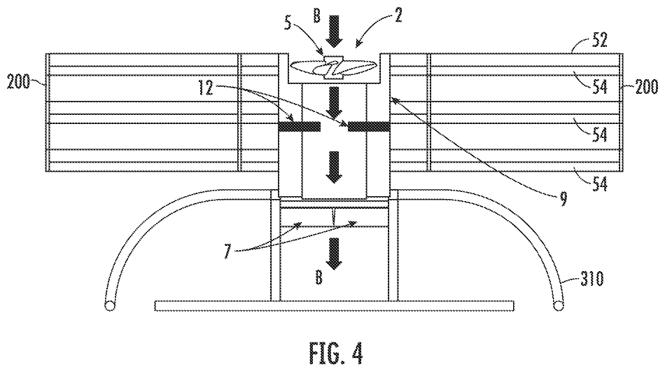

As seen in FIG. 4 from a sectional view of the invention, the housing 9 consists of a hollow chamber which allows the airflow produced by the impeller 5 to flow from the impeller 5 through housing 9 towards the thrust vectoring fins 7 in the direction of arrows B. The housing 9, as described below, also holds the electronics 12, energy storage devices 100, 204, and flight control systems 202, 208 by way of example. As a result air flow from impeller 5 cools down on board electronics 12 of craft 10 during operation.

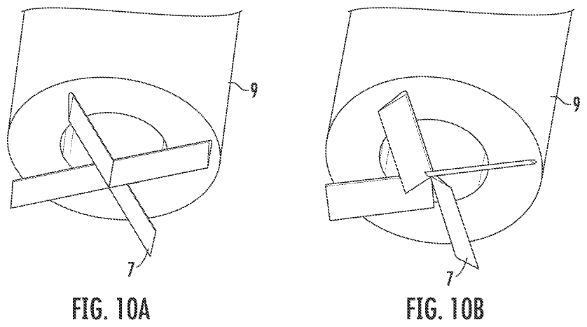

FIG. 10A shows one example of the articulation of the thrust vectoring fins 7. Each of the pivoting fins 7 can independently rotate, under the control of servos 210 to change their angle of incidence, as shown in FIG. 10B by way of example, such that the air flow produced by the secondary thrust system 2 is directionally directed as it exits housing 9 to control the Pitch, Roll, and Yaw of the craft 10; i.e., steer craft 10 as well as provide additional thrust in the vertical direction as needed. Changes in the Pitch, Roll, and Yaw of the craft results in the FWD, AFT, Left or Right translation or rotation of the craft 10.

Reference is now made to FIG. 5 in which a schematic diagram of the general configuration and operational interaction between the ion thruster 1, the primary thrust system, and the thrust vectoring system 2, the secondary thrust system, is provided. The primary thrust system 1 is powered by an on-board energy storage unit 100. A plurality of energy storage devices can be used to provide power to the primary thrust system 1. These include, Lithium Batteries, Lithium-Nickel, Fuel Cells, ultra and mega capacitors by way of non limiting example.

The energy storage unit 100 is operatively coupled an ON/OFF switch 102. The ON/OFF switch 102 is also operatively coupled to a DC to AC high frequency generation unit 104 and allows or denies the voltage that is provided to the DC to AC high frequency generation unit 104. The DC to AC high frequency generation unit 104 converts the current from DC to AC which is input to one or more step-up transformer(s) 106 to increase the voltage to about four hundred times that of the energy storage unit 104 in the preferred non limiting example.

The step-up transformer(s) 106 is operatively coupled to a voltage multiplier/rectifier 108 which further increase the voltage by about six times that of the voltage output of the DC to AC high frequency generation unit 106 in the preferred non limiting example. The voltage multiplier/rectifier 108 also converts the current from AC to DC. The top electrodes 52 and bottom electrodes 54 are operatively connected to voltage multiplier/rectifier 108 and receive therefrom the high potential differential required to generate ion thrust. It should be understood that ion thrust system 1 is entirely supported by frame 200.

Thrust vectoring system 2 includes a flight controller 202 which controls the flight; the Pitch, Roll, and Yaw of the craft 10. Flight controller 202 is operatively connected to the ON/OFF switch unit 102 of the ion thrust system 1 and provides the signals which determine the ON/OFF state of the switch to allow or deny voltage from the energy storage unit 100 to the DC to AC high frequency generation unit 104.

An energy storage unit 2 204 provides power to the flight controller 202, a receiver 206, gyroscopes/one or more GPS systems 208, servos to articulate thrust vectoring fins 210 to pivot about an axis and propeller rotating motors 212 to control the speed of rotation of impellers 5; which control operation of the fins 7 and impellers 5 respectively.

During operation receiver 206 receives remote commands from a remote (not on board) transmitter 250 which then are input into the flight controller 202. Transmitter 250 may be wiredly connected to vectoring system 2, but in a preferred non limiting embodiment, wirelessly communicates with flight controller 202. Commands from the transmitter 250 dictate the flight path of the craft 10 by controlling operation of thrust vectoring system 2, and more particularly the operation of pivoting vectoring fins 7. Also, the flight controller 202 can be programmed with a flight path to operate the craft autonomously.

Gyroscopes and GPS embedded in gyroscope and GPS system 208 are also operatively connected to the flight controller 202. Signals from the gyroscopes and GPS system 208 are used as feedback by the flight controller 202 to determine the angle of orientation and rotation of the thrust vectoring fins 7 to achieve controlled, agile, level flight as well as movement in the right, left, AFT, FWD, up or down directions. Again thrust vectoring system 2 is disposed on frame 200; it's on board craft 10 and the downdraft from impellers 5 is used to cool on board electronics 12 as well as provide thrust for controlling flight. Craft 10 can also be fully autonomous with the use of an onboard programmable flight controller 202 to self-control its flight path and trajectory

### INDUSTRIAL APPLICABILITY

The invention is further illustrated by the following non-limiting examples in which like numerals are used to indicate like structure.

### EXAMPLE 1

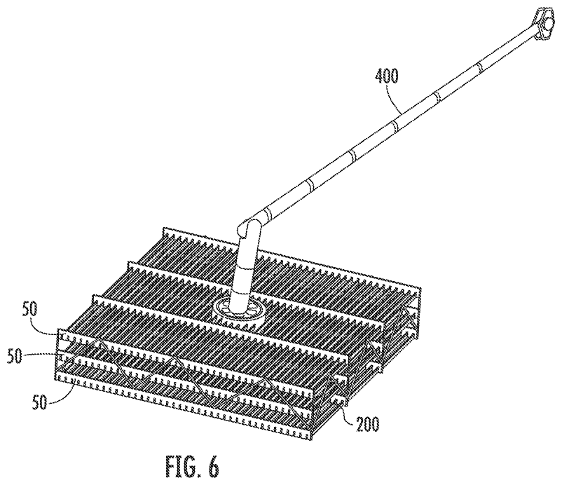

The above UAV 10 was reduced to practice using the experimental set-up shown in FIG. 6. The experimental set-up comprised 3 feet long by 3 feet wide by 1-foot tall UAV 10. The UAV 10 consisted of three levels of electrode pairs 50, each with a total of twenty lower electrodes 54 and nineteen top electrodes 52. From a top view, the center of the craft has a 9 inches by 9 inches opening to provide the provisions and space for the thrust vectoring system 2. The bottom electrodes 54 were made of cardboard foam and wood covered by aluminum foil. All electrodes 52, 54 were made from conductive material. For all levels of electrode pairs 50, the maximum potential differential (voltage) was set to about 60 KV. The above-described structure may be repeatedly provided in a stacked structure as shown in FIG. 1 and FIG. 6.

The craft 10 was fixed to a balance wood swing 400 that allowed upward/downward motion of the craft 10 but limited the other degrees of freedom. The wood swing 400 was balanced so that it did not contribute to the upward or downward thrust of the craft 10. The craft 10 was fitted with an on-board surveillance sensor, such as a camera (not shown). The experiment demonstrated a controlled upper lift trajectory of the craft 10 of five feet. The maximum noise generated by the craft 10 was measured using a noise meter three feet away from the craft 10. The maximum level of noise recorded was 60.9 decibels.

The preceding example was for a three level (stages) electrode pair thruster. The example can be repeated using a plurality of electrode configurations and a plurality of voltage polarities supplied to the electrodes.

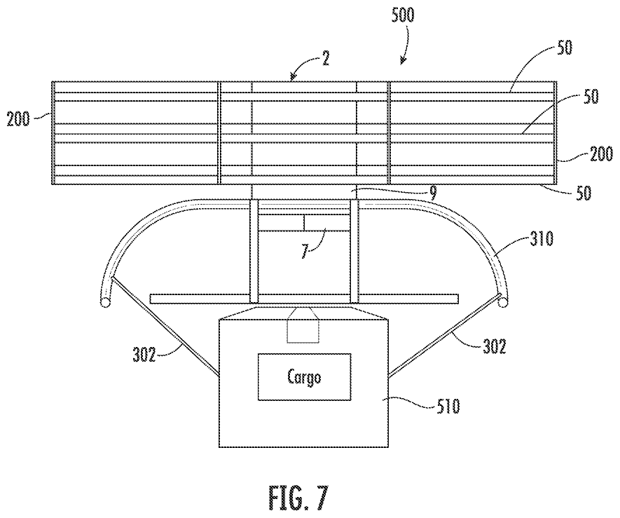

As illustrated in FIG. 7, in another embodiment of the invention, in which a craft 500 can be fitted to carry and deliver cargo is presented. Like numbers are used to indicate like structures. Craft 500 includes frame 200 and spaced rows of electrode pairs 50 forming ion thrust 1 and part of the support structure for craft 500. As described above, thrusting vectoring system 2 is mounted within the frame 200. Landing gear 300 is configured and dimensioned to receive a package 510 at least partially therein. Releasable straps 302, by way of non limiting embodiment, extend from landing gear 300 and are releasably attached, as known in the art, to a package (cargo) 510.

Releasable straps 302 may be ropes, spooled cords, bungie cords, netting or the like which can be fixed to landing gear 310 at one end, and releasably attached to package 510 at the other end. Once package 510 is detached, released, from landing gear 310, craft 500 may land on landing gear 310 as known from above.

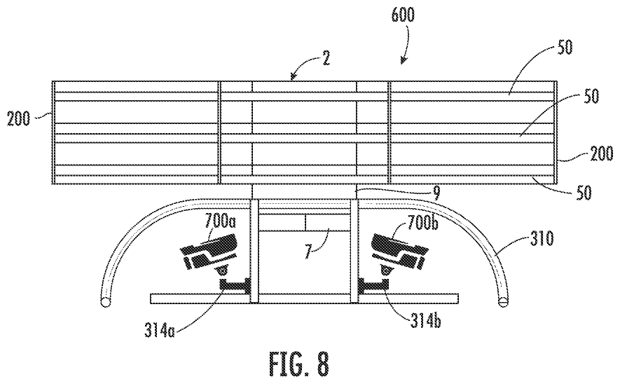

As illustrated in FIG. 8, another embodiment, constructed in accordance with the invention; a craft 600 fitted with surveillance devices 700a, 700b to conduct surveillance missions is provided. Like numbers are used to indicate like structures. Again, craft 600 includes frame 200 and spaced rows of electrode pairs 50 forming ion thrust 1 and part of the support structure for craft 500. As described above, thrusting vectoring system 2 is mounted within the frame 200. Landing gear 300 is configured and dimensioned to support sensors 700a, 700b thereon.

In a preferred embodiment sensors 700a, 700b are visual cameras, but they may be infrared cameras, audio receivers, magnetometers, radar guns or the like. When sensors are cameras 700a, 700b they may be mounted directly to the undercarriage structure of landing gear 300, or onto mounts 314a, 314b each affixed to both a respective camera 700a, 700b at one end and landing gear 300 at another. Sensors 700a, 700b can be fixed or move relative to landing gear 300 and/or supports 314a, 314b to increase the range

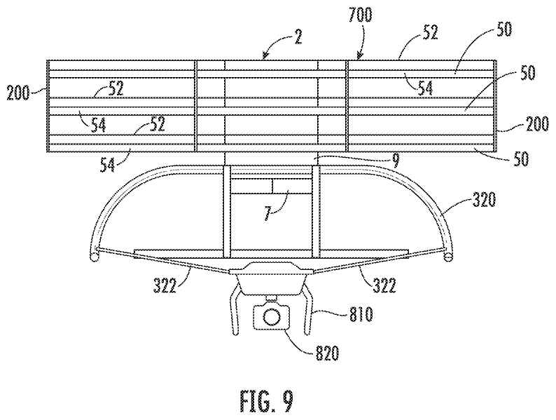

As illustrated in FIG. 9, a craft 700 constructed in accordance with another embodiment of the invention is adapted to be used to retrofit existing multi-copters by removing their arms, propellers and motors to be then attached to the landing gear 300. Like numbers are used to indicate like structures. Craft 700 includes frame 200 and spaced rows of electrode pairs 50 forming ion thrust 1 and part of the support structure for craft 500. As described above, thrust vectoring system 2 is mounted within the frame 200. Landing gear 300 is configured and dimensioned to receive another type of UAV, such as a multicopter 800, at least partially therein. Supports 322, by way of non limiting embodiment, extend from landing gear 320 and are releasably attached as known in the art to a the multicopter 800.

Multicopter 800 may have its own landing skids 810 and monitoring sensor(s) 820. Supports 322, may be releasable straps 302 as described above, but in a preferred nonlimiting embodiment, are fixed rigid supports, such as metal or plastic bars. In this way craft 700 can make use of landing skids 810 of multicopter 800 when landing. Additionally, the control systems of the multicopter 820 can then be paired with the on-board flight controller 202 of the craft 700 and be used to remotely control the flight of the joined units.

As a result of the above embodiments and construction a VTOL craft which uses the electrodes of the ion thruster as part of the primary structure frame of the craft is provided. As a result, a craft which possesses no wings, arms, or engines attached to arms is provided. Nor does the craft require changes in the orientation of the primary lift off engines to direct thrust. Additionally, because of the thrust vectoring structure, the above described craft does not require any changes in the orientation of the primary thrust engines to direct thrust. Pivoting fans are used to direct the flow of air to achieve controlled flight in any direction while still maintaining acceptably of low noise levels.

By positioning the electronics within the same housing which supports the thrust vectoring system, the air flow from the thrust vectoring system is also used to provide cooling to the on-board electronics. The electronics are exposed to the airflow produce by the propeller thru openings in the hollow chamber.

Although the invention has been described in detail with particular reference to these described embodiments, other embodiments can achieve the same results. Variations and modifications of the present invention will be obvious to those skilled in the art and it is intended to cover in the appended claims all such modifications and equivalents.

What is claimed is:

1. A vertical take-off and landing (VTOL) unmanned vehicle which generates low levels of noise comprising: an ion thruster providing a thrust in a vertical direction, and a thrust vectoring system providing thrust in at least one of a forward, aft, left, and right direction, when the unmanned vehicle is in flight.

2. The VTOL craft of claim 1, further comprising a frame, wherein the ion thruster includes electrodes, the electrodes of the ion thruster forming part of the frame.

3. The VTOL craft of claim 1, further comprising a housing supported by the frame; the thrust vectoring system being disposed in the housing and including an impeller mounted on the housing, two or more pivoting fins, mounted on the housing, to direct a flow of air created by the impeller to flow in a desired direction form the housing.

4. The VTOL craft of claim 1, further comprising electronics for controlling each of the impeller and the pivoting fins, the electronics being disposed in the housing between impeller and the pivoting fins; the housing defining a path for the flow of air between the impeller and two or more pivoting fins, the electronics being disposed along the path.

5. The VTOL craft of claim 4, wherein the electronics include a flight controller for controlling the pivoting fins during flight, and a gyroscope/GPS system for determining a position of the VTOL craft and outputting a feedback signal as a function of the determined position to the flight controller for controlling the pivoting of the fins.

6. The VTOL craft of claim 2, the thrust vectoring system being mounted on the frame, wherein the thrust vectoring system communicates with a transmitter, the transmitter not mounted on the craft, for receiving control signals from the transmitter for operating the thrust vectoring system.

7. The VTOL craft of claim 2, wherein the electrodes are formed as electrode pairs, each row of electrode pairs forming a stage; the ion thruster being formed as multiple stages and being under the control of electronics; and a housing disposed in the multiple stages, the thrust vectoring system being disposed in the housing, the thrust vectoring system including two or more pivoting fins to direct a flow of air from within the housing, to outside of the housing to achieve a controlled flight, and provide cooling to the on-board electronics disposed in the housing.

8. The VTOL craft of claim 2, further comprising a landing skid mounted to the frame to provide support when the craft is disposed on the ground.

9. The VTOL craft of claim 8, wherein the landing skid is adapted to support cargo therein.

10. The VTOL craft of claim 8, further comprising a camera disposed on the landing skid.
